(19) United States
(12) Patent Application Publication
(10) Pub. No.: US 2002/0004164 A1
(43) Pub. Date: Jan. 10, 2002

(54) GALVANSORPTIVE REACTION CELL

(76) Inventor: PETER VINZ, GARMISCH-PARTENKIRCHEN (DE)

Correspondence Address: BROWDY AND NEIMARK, P.L.L.C., 624 NINTH STREET, NW, SUITE 300, WASHINGTON, DC, 20001-5303, US

(21) Appl. No.: 08/875,916

(22) PCT Filed: Feb. 6, 1996
(86) PCT No.: PCT/DE96/00182

(30) Foreign Application Priority Data
Feb. 8, 1997 (DE) 195 04 159.3

(51) Int. Cl. H01M 8/00

(52) U.S. Cl. 429/105; 429/15; 429/46; 429/108

(57) ABSTRACT

The invention relates to a galvanosorptive reaction cell with closed substance circulation for the conversion of low temperature heat, preferably of waste heat into useful electrical work. The reaction cell and the accompanying isobaric substance circuit are presented. The galvanosorptive reaction process inside the cell is carried out polytropically with an electrostatic auxiliary voltage, which is superimposed onto the inherent voltage of the cell. In this way, not only free but, with cooling of the reaction system, also substance-bound reaction work can be extracted from the reaction system. The electrical energy yield and the power density of galvanosorptive reaction cell are thereby increased many times over.

The invention relates to a galvanosorptive reaction cell for the conversion of sorptive reaction work into useful electrical work, whereby a ternary substance system consisting of a carrier gas/vapour mixture and a solution absorbing the vapour is fed to and carried off from the reaction cell, as well as the formation of the fed-in and carried-off substance flows into an isobaric substance circuit with thermal decomposition of the solution and separation of the solution components outside the reaction cell.

A galvanic reaction cell of a modified type, with hydrogen and an aqueous ammonia solution in an isobaric substance circuit with thermal decomposition of the solution and re-liquefaction of the evaporated solution component carried out outside the reaction cell is known from DE 3302635 A1. Both the design of the galvanic reaction cell and the design of the isobaric substance circuit are disadvantageous for the galvanic reaction mechanism inside the cell and its operational behaviour.

On the one hand, the ammonia fed in liquefied form on the cathode side to the reaction cell contains residual portions of water, which during the operation leads to a constant dilution of the liquid ammonia in the reaction cell and thus after a short time to an operational standstill, because a continuous extraction of diluted ammonia from the cell is lacking. On the other hand, the non-meterable substance circuit gives rise to an unsteady power and voltage behaviour of the reaction cell. Moreover the method, in which the waste heat of the ammonia liquefaction is to be left in the substance circuit and the thermal efficiency of the thermogalvanic energy conversion thereby raised, is based on process features that do not permit a recovery of the liquefaction waste heat, for example the liquefaction of overheated ammonia vapour at a higher temperature than the saturation temperature.

In addition, on account of the low solubility of gaseous hydrogen in liquid ammonia the stoichiometric introduction of the reactands to the reaction zone of the cathode is possible only to a limited extent, which has a diminishing effect on the substance conversion and thus on the electrical energy yield. An additional reduction of the energy yield arises due to the partial vapour pressure drop resulting from the isobaric mixing of hydrogen and liquid ammonia inside the reaction cell.

An in principle different kind of reaction cell with a closed isobaric substance circulation is known from the documents DE-OS 1596143 and DE-OS 1599153. An aqueous hydrogen halide solution acts as the substance system, said hydrogen halide solution being partially decomposed electrolytically, i.e. with the additional of electrical energy, into elementary hydrogen and the corresponding liquid halogen, whereby the decomposition products are again fed to a recombination cell and converted into the aqueous initial solution with the release of electrical energy. Here, a finite amount of ambient heat is to be converted into useful electrical energy, which former ultimately results from the useful voltage difference of both process steps. Use is made inside the recombination cell of the chemical reaction work and not the sorptive reaction work, which is lost with the disclosed recombination cell and therefore can be expended as additional electrical energy in the electrolytic separation.

The basis adopted here was the ideal voltage values of the decomposition and the recombination of the substance system, which are known to represent equilibrium values and consequently do not show any substance conversion into one of the reaction directions. As soon as a noticeable substance conversion is generated, the voltage values of both reaction steps become alike, as a result of which the disclosed work gain is reduced. In addition, the loss of the sorptive reaction work reduces the work gain, so that a technical exploitation of this effect holds out little promise.

Furthermore, there is described in EP 0531293 an isobaric process for the conversion of sorptive reaction work into electrical work with a closed ternary substance circulation with the use of a carrier gas and a thermally decomposable, sorptively acting aqueous solution, whereby the energy conversion is intended to be carried out in a galvanosorptive reaction cell, the thermal decomposition of the solution and separation of the solution components on the other hand outside the reaction cell. Further galvanosorptive and electrochemical energy conversion processes with isobaric substance circuits are known from EP-OS 91917497. Neither the design of this novel, galvanosorptive reaction cell, nor the reaction mechanisms taking place inside the reaction cell and influencing the design emerge from these two documents, so that an essential prerequisite for the technical exploitation of the principle is lacking.

One task of the invention therefore is the design in principle of a technically exploitable, galvanosorptive reaction cell for the conversion of sorptive reaction work into useful electrical work taking account of the reaction mechanisms taking place inside the cell in the sorption process. Another task of the invention is the formation of the fed-in and carried-off substance flows into an operationally stable, regulatable, isobaric substance circuit with high process efficiency, whilst avoiding the previously mentioned disadvantages of the galvanic reaction cell. A further task of the invention is the increase of the electrical energy yield of this gaivanosorptive reaction cell over and above the substance conversion by utilising the latent and sensitive heats contained in the substance flows fed to it.

The task of the technically exploitable design in principle of a galvanosorptive reaction cell is solved with the combinations of features of claim 1 for a membrane electrolyte cell and with the combinations of features of claim 2 for a liquid gap cell, whereby both cell configurations enable, without geometric modifications, both the anion-generating and the cation-generating reaction mechanism. With the sorptive liquefaction of the vapour in the solution generating useful work, premature substance conversion limitations of the galvanic reaction cell are removed in an advantageous way for the galvanosorptive cell, as for example the low hydrogen solubility in liquids and the inability of the galvanic cell to gain a portion of the liquefaction heat directly as reaction work. In this way galvanosorptive reaction cells achieve higher energy yields and efficiencies than galvanic reaction cells.

According to the combinations of features of claim 3, any sorptive liquid mixtures thermally decomposable into a vapour component and a liquid component, in combination with a carrier gas forming ions with the vapour, as for example hydrogen or oxygen, can be used in the galvanosorptive reaction cells for the galvanosorptive reaction process.

An electrolyte soluble in the solvent and with negligible inherent vapour pressure can be added to the individual substance system if need be in order to improve the ion conductivity, as a result of which the internal resistance of the reaction cell can be reduced in an advantageous manner. The structural materials of these reaction cells do however need to be suited to the selected substance system.

Such liquid mixtures combinable with a carrier gas are for example the aqueous solutions of NH₃, H₂SO₄ or LiBr or the solution NH₃/LiNO₃. These and further solutions were investigated by Niebergall in “Working substance pairs for absorption refrigeration systems” with regard to their utilisability at low temperatures. The low temperature use of these solutions is also advantageous for the thermogalvanic energy conversion, because the waste heat of many technical processes can thus be used as a cost-free, convertible heating energy potential.

According to the process features of claim 5, the vapour partial pressure difference acting in the galvanosorptive cell between the carrier gas-vapour mixture and the sorptive solution can be raised not only via the overall system pressure and hence via the one-off carrier gas filling, but also via the circulation rate of the vapour-storing carrier gas conveyed in the circuit. This gives rise to an increase in the useful voltage without additional mechanical loading of the built-in cell components, with only slightly higher power consumption of the gas compressor arranged in the external part of the substance circuit. This advantageous possibility is likewise not available with the galvanic reaction cell disclosed in DE 3302635 A1.

The adiabatic running of the process inside the galvanosorptive reaction cell results in a simplified cell design in terms of its structure, because it is possible to dispense with corresponding heat transfer channels inside the cell. According to the features of claim 4, such channels are required for the non-adiabatic running of the process. Through them flows a heat transfer medium, preferably a solution of the same kind, which is in thermal contact with the absorbing solution and the electrode wetted by the solution and can both cool and heat the reaction cell.

The task of increasing the electrical energy yield of the galvanosorptive reaction cell is solved according to claim 6 with the assignment of an activation source, which permanently confers on the electrodes a quasi electrostatic voltage difference from outside, whereby the latter can amount to several volts and is superimposed on the inherent voltage difference of the cell. It gives rise within the reaction cell to a sorptive vapour liquefaction along with a temperature drop of the concentrating solution, whereby the applied voltage difference is proportional to the temperature drop and inversely proportional to the increase in concentration of the solution and is available as a working voltage difference at the external load resistor less the cell voltage losses. Using this measure, the power density of the galvanosorptive cell is also increased apart from the useful electrical work yield and the thermal efficiency further raised.

With the combinations of features of claim 7, the substance flows fed to and carried off from the reaction cell are formed into an isobaric, substance circuit, which makes available in an operationally stable fashion the substance potential difference of the galvanosorptive reaction cell, is regulatable via the conveying devices independent of one another and exhibits a high thermogalvanic efficiency with the combined process components.

If the electrostatic voltage of the activation source acts on the reaction process inside the galvanosorptive reaction cell, then with the combinations of features of claim 8 the process engineering expenditure in the external part of the substance circuit is clearly simplified and the energy yield of the galvanosorptive reaction cell increased.

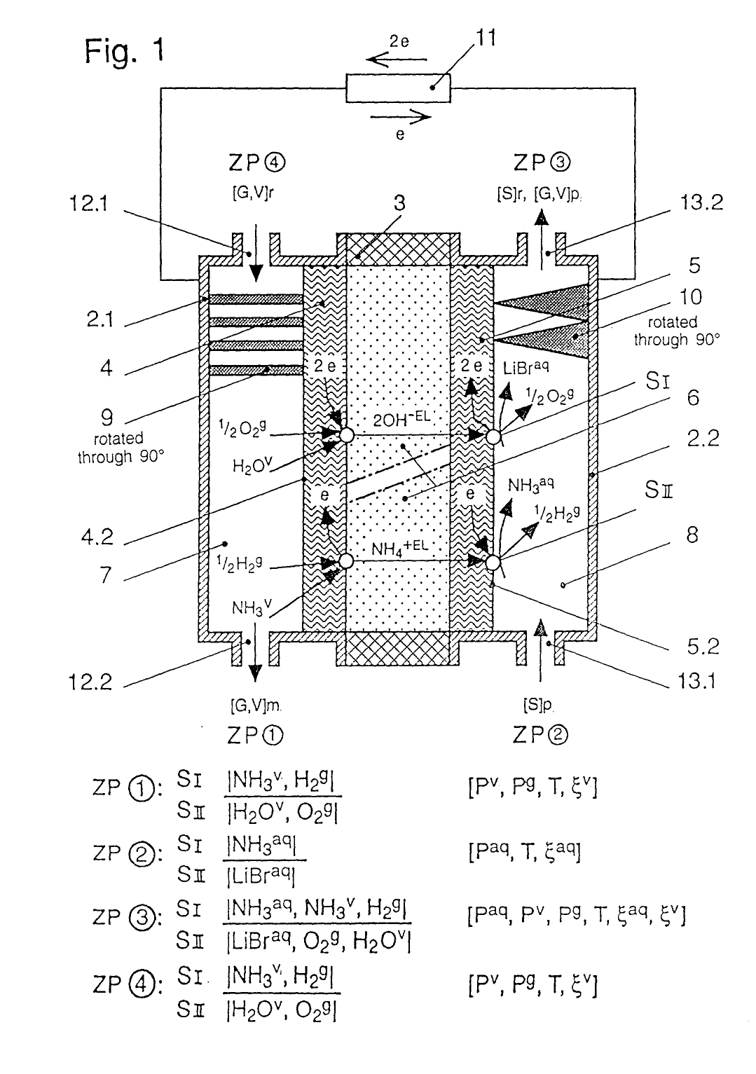

The invention is described with the aid of the FIGS. 1 to 7. In detail, the figures show:

FIG. 1 the functional principle and the schematic structure of a universally utilisable, galvanosorptive membrane electrolyte cell, with the exemplified representation of an anion-generating, ternary substance system SI: [O₂^{g}, H₂O^{v}] [OH^{-EL}, El] [LiBr_{aq},O₂^{g}] and a cation-generating, ternary substance system SII: [H₂^{g}, NH₃^{v}] [H₃O^{+EL}, El] [NH₃^{aq},H₂^{g}],

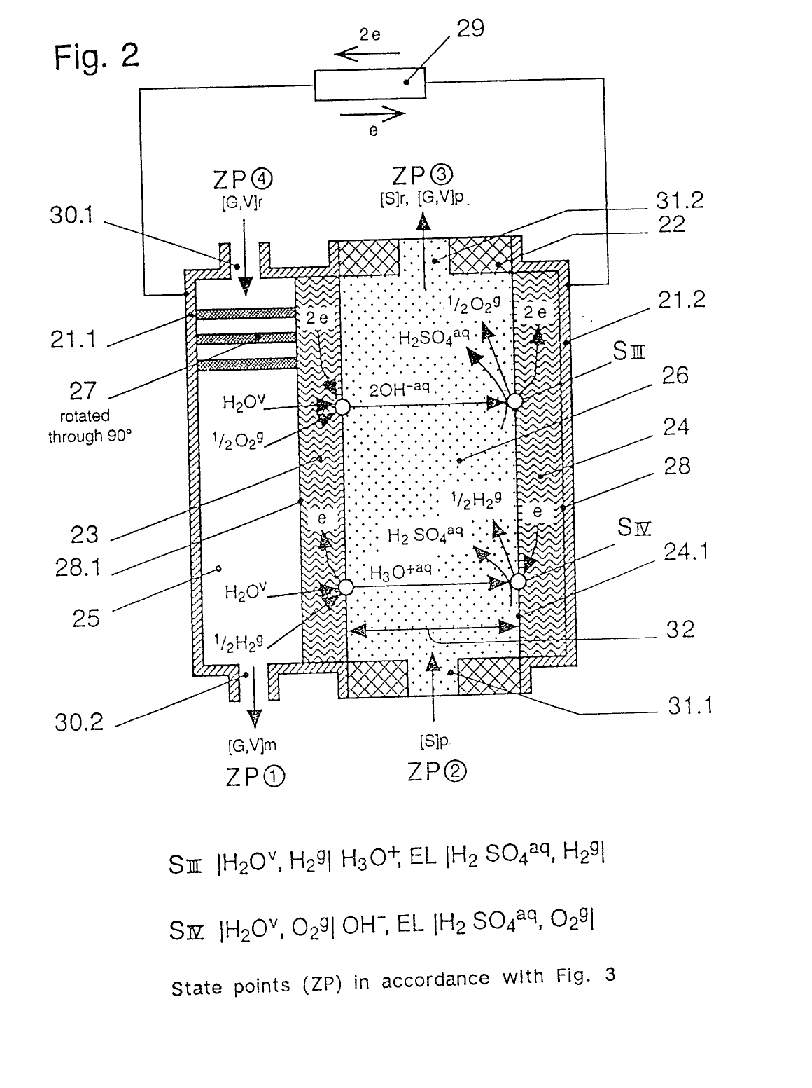

FIG. 2 the functional principle and the schematic structure of a universally utilisable galvanosorptive liquid gap cell with the examplified representation of an anion-generating, ternary substance system SIII: [O₂^{g}, H₂O^{v}] [OH^{-aq},H₂SO₄^{aq}] [O₂^{g}, H₂SO₄^{aq}] and a cation-generating, ternary substance system SIV: [H₂^{g}, H₂^{g}H₂O^{v}] [H₃O^{+aq}, H₂SO₄^{aq}] [H₂SO₄^{aq}, H₂^{g}],

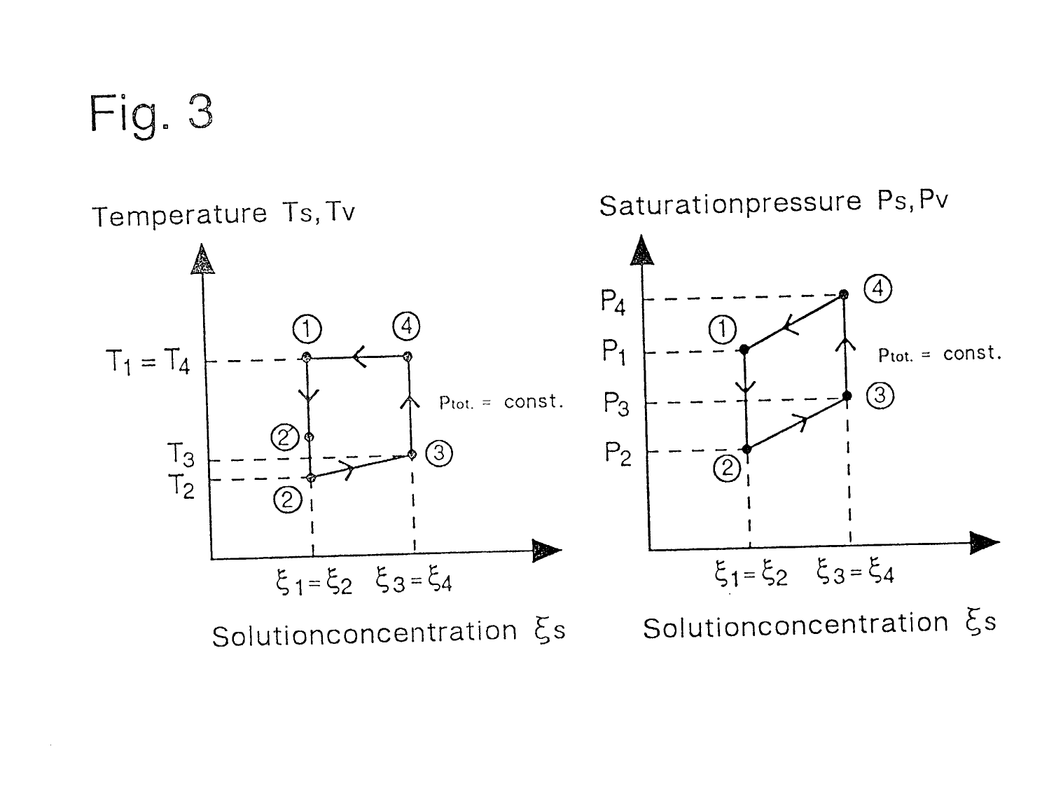

FIG. 3 the cyclic process and the substance states of an adiabatic galvanosorptive reaction cell in a schematic T/ξ and P/ξ diagram for an arbitrary, ion-generating, ternary substance system,

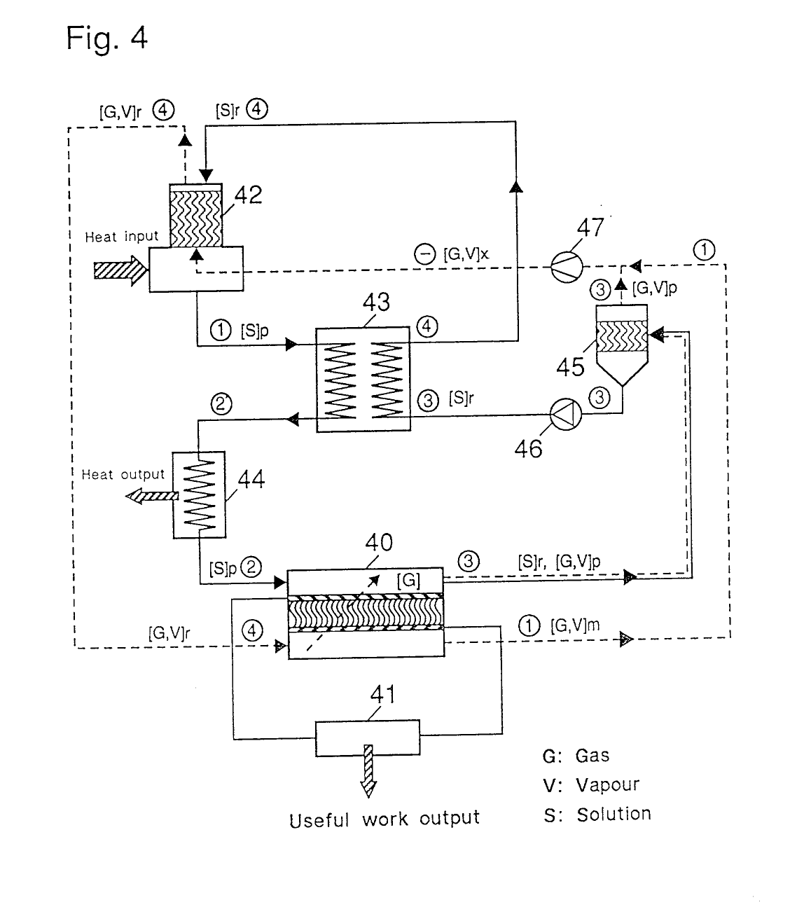

FIG. 4 the functional circuit diagram of a galvanosorptive reaction cell with closed, isobaric substance circuit according to the cyclic process as per FIG. 3,

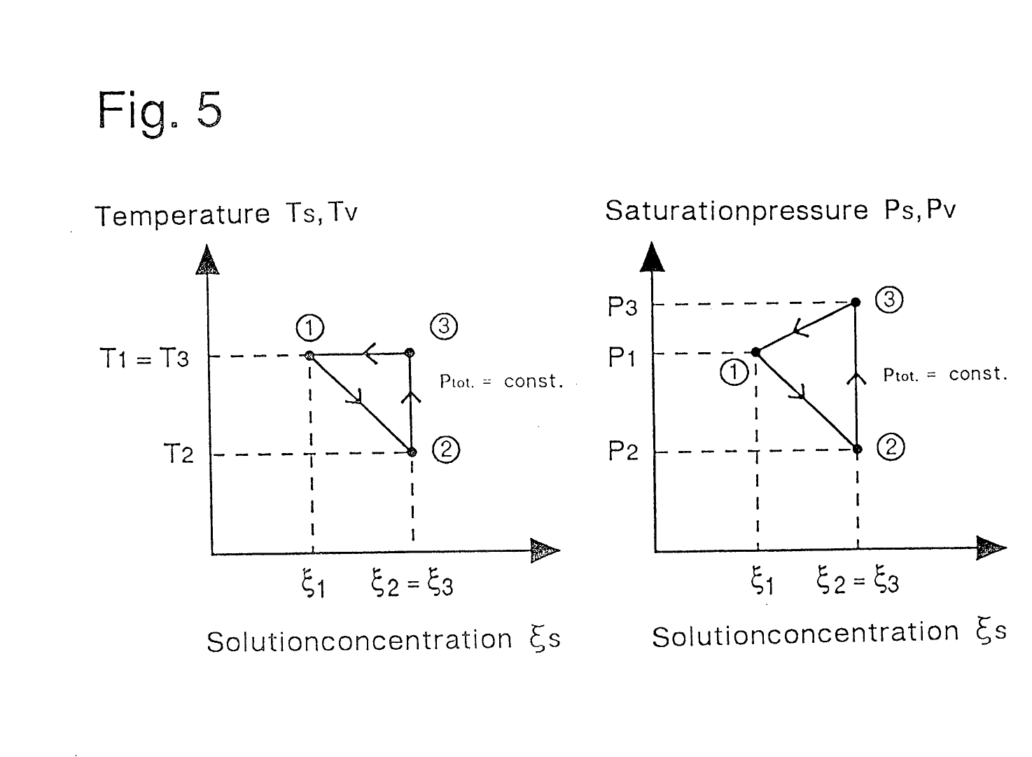

FIG. 5 the cyclic process and the substance states of the galvanosorptive reaction cell with electrostatic support for an arbitrary, ion-generating, ternary substance system in a schematic T/ξ and P/ξ diagram,

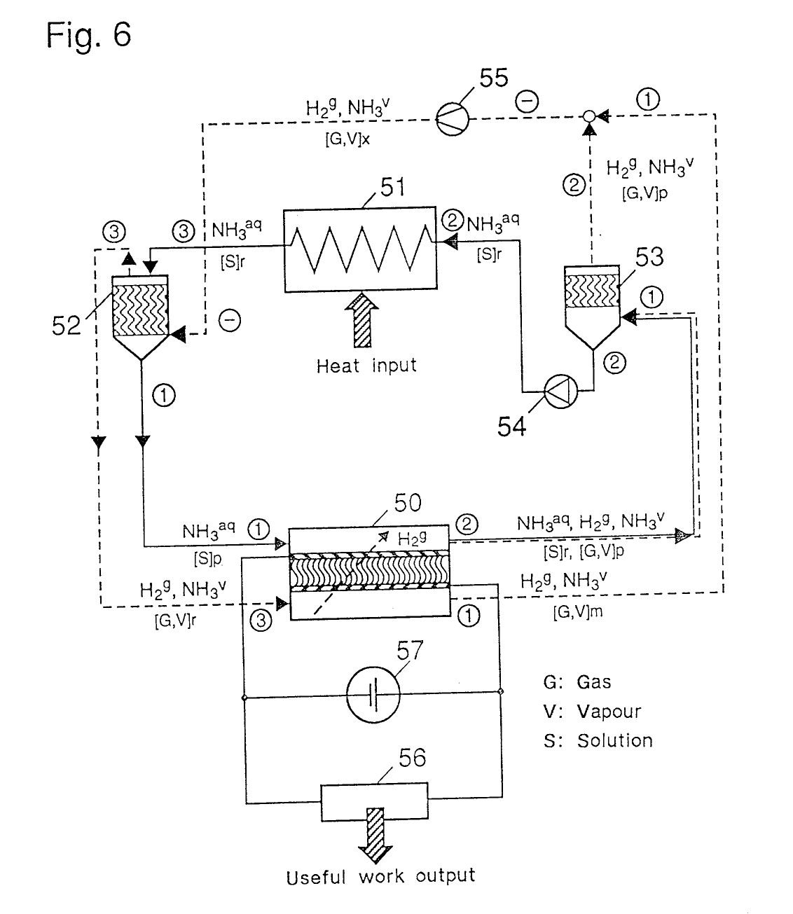

FIG. 6 the functional circuit diagram of a galvanosorptive reaction cell with electrostatic support and closed, isobaric substance circuit in accordance with the cyclic process as per FIG. 5, and

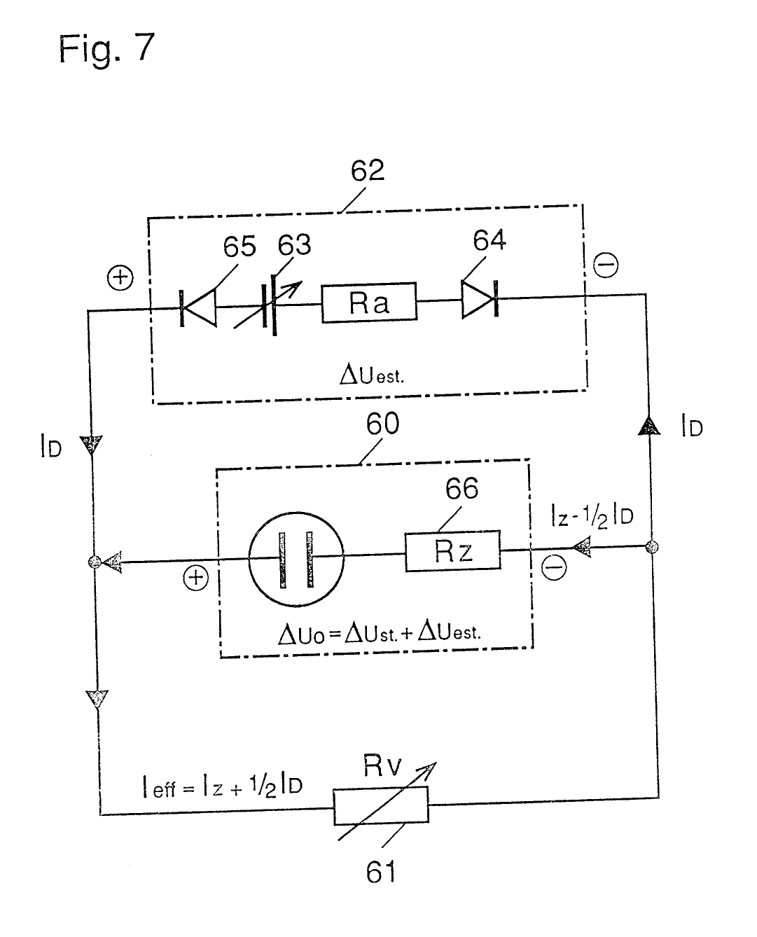

FIG. 7 schematically, the electrical equivalent circuit diagram of the galvanosorptive reaction cell with assigned activation source.

The structure and mode of functioning of the galvanosorptive membrane electrolyte cell will be explained in greater detail with the aid of the examples of embodiment of FIG. 1.

The membrane electrolyte cell consists of a cell housing (2), which is divided by a media-sealing, galvanically separating peripheral seal (3) into a first housing part (2.1) and a second housing part (2.2). The housing (2) contains a flat-shaped, porous, gas-permeable first electrode (4) and a flat-shaped, porous, gas- and liquid-permeable, second electrode (5). Between the electrode faces there is arranged alternatively a selectively cation- or selectively anion-permeable membrane electrolyte (6), which forms a mechanically stable composite unit with the porous electrodes (4,5). The first electrode face (4.2) facing away from the membrane electrolyte (6) forms with the first housing part (2.1) a slit-shaped gas channel (7), through which there flows a vapour-saturated, cation-generating carrier gas type [G,V] or a vapour-saturated, anion-generating carrier gas type [G,V]. The second electrode face (5.2) facing away from the membrane electrolyte (6) forms with the second housing part (2.2) a slit-shaped liquid channel (8), through which there flows an undersaturated, vapour-absorbing solution [S]. The electrodes (4,5) are electrically short-circuited by current lead-in and lead-off devices (9,10) and an external load resistor (11). The current lead-in and lead-off devices (9,10) represented schematically are arranged in FIG. 1 rotated through 90°. They are constructed geometrically like the conduction systems known from fuel cells, so that they reduce only slightly the reactive surfaces of the electrodes and do not hinder the through-flow of the slit-shaped channels (7,8).

Via openings (12.1, 12.2) in the first housing part (2.1), a vapour-saturated carrier gas [G,V]r, (ZP4) with high vapour partial pressure is fed to the gas channel (7) and a reduced quantity of vapour-saturated carrier gas [G,V]m, (ZP1) with reduced vapour partial pressure is carried off. Via openings (13.1, 13.2) in the second housing part (2.2), an undersaturated solution [S]p, (ZP2) with lower vapour concentration and low vapour partial pressure is fed to the liquid channel (8) and a two-phase mixture [S]r, [G,V]p, (ZP3) of undersaturated solution [S]r, (ZP3) with raised vapour concentration and low vapour partial pressure and vapour-saturated carrier gas [G,V]p, (ZP3) with the same low vapour partial pressure is carried off.

When use is made of a cation-generating gas type, as for example hydrogen, and a membrane electrolyte (6) selectively letting through this cation type, cations are formed at the phase boundary (4.1) (gas/solid/electrolyte) of the first electrode (4) as a result of anodic oxidation with the consumption of hydrogen and vapour from the gas channel (7). These migrate through the membrane electrolyte (6) to the second electrode (5) and at its phase boundary (5.2) (gas/liquid/solid) increase the concentration of the solution flowing in the liquid channel (8) as a result of cathodic reduction, with the liberation of an equivalent quantity of hydrogen. The electrons flow here from the first electrode (4) via the conduction devices (9,10) and the external load resistor (11) to the second electrode (5).

When use is made of a anion-generating gas type, as for example oxygen, and a membrane electrolyte (6) selectively letting through this anion type, anions are formed at the phase boundary (4.1) (gas/solid/electrolyte) of the first electrode (4) as a result of cathodic reduction with the consumption of oxygen and vapour from the gas channel (7). These migrate through the membrane electrolyte (6) to the second electrode (5) and at its phase boundary (5.2) (gas/liquid/solid) increase the concentration of the solution flowing in the liquid channel (8) as a result of anodic oxidation with the liberation of an equivalent quantity of oxygen. The electrons flow here from the second electrode (5) via the current conduction devices (10,9) and the external load resistor (11) to the first electrode (4).

To the fluid flows fed to and carried off from the membrane electrolyte cell according to FIG. 1 there are assigned the state points (ZP1 to ZP4) marked by circles, which represent saturation equilibriums for the respective fluid flows and are defined by their state magnitudes [P,T,ξs,ξv]. They relate to the cyclic process according to FIG. 3. The substance potential difference of the galvanosorptive reaction process inside the membrane electrolyte cell arises with the local assignment of the substance flows on the reaction cell. For this, the vapour-saturated gas flow is conveyed, with transverse removal by suction of a partial quantity, preferably in the opposite direction to the solution flow, parallel to the electrode faces through the cell. The vapour concentration ξV is constant during the reaction process.

An aqueous solution of lithium bromide in combination with oxygen as an anion-generating reaction system (SI) and an aqueous ammonia solution in combination with hydrogen as a cation-generating reaction system (SII) were selected as examples of ternary substance systems for the membrane electrolyte cell. Two further, ternary substance systems of aqueous sulphuric acid in combination with oxygen (SIII) and in combination with hydrogen (SIV) are presented in FIG. 2 for the liquid gap cell. In the substance systems (SI, SIII and SIV), water is the vaporising mixture component and in substance system (SII) ammonia. The selected examples of ternary substance systems can be applied to both types of cell structure. The galvanosorptive reaction systems read as follows:

SI: [O₂^{g},H₂O^{v}], [OH^{-EL}, El], [LiBr^{aq},O₂^{g}] (anion-generating)

SII: [H₂^{g},NH₃^{v}], [NH₄^{+EL},El], [NH₃^{aq},H₂^{g}] (cation-generating)

SIII: [O₂^{g},H₂O^{v}], [OH^{-aq},H₂SO₄^{aq}], [H₂SO₄^{aq},O₂^{g}] (anion-generating)

SIV: [H₂^{g},H₂O^{v}],], [H₃O^{+aq},H₂SO₄^{aq}], [H₂SO₄^{aq},H₂^{g}] (cation-generating)

The electrode pairs and the membrane electrolytes [El] are indeed geometrically alike in the selected reaction systems, but differ in their mode of functioning and in the material structure. The electrode reactions are stated in greater detail for the substance system (SII):

| | |
|---|---|
| Reaction system | a\|(NH₃^{v}, H₂^{g})^{a}\|NH₄^{+EL}, E1\|NH₃^{aq}, H₂^{g})^{β}\|β |
| (S_{II}): | |
| Cathode reaction a: | e^{a} + NH₄^{+EL} = (NH₃^{v} + ½H₂^{g})^{a} |
| Anode reaction β: | (NH₃^{aq} + ½H₂^{g})^{β} = NH₄^{+EL} + e^{β} |
| Cell reaction | e^{a} + (NH₃^{aq} + ½H₂^{g})^{β} = (NH₃^{v} + ½H₂^{g})^{a} + e^{β} |
| (a + β): | |
| Substance potential | (φ^{β} − φ^{a})ₛₜ = (R × T/F) × In[(Pₐ/P_{β})_{NH3} × |
| difference: | (Pₐ/P_{β})^{½}_{H2}] |
| Electrostatic | (φ^{β} − φ^{a})_{est.} = [Cp × (T₁-T₂)_{NH3aq.} ± Q_{rev.}]/F |
| potential | |
| difference: | |

As a further development of the invention, the structure and mode of functioning of a galvanosorptive liquid gap cell are described in greater detail with the aid of the examples of embodiment of FIG. 2.

The liquid gap cell consists of a cell housing (21), which is divided by a media-sealing, galvanically separating peripheral seal (22) into a first housing part (21.1) and a second housing part (21.2). The housing (21) contains a flat-shaped, mechanically stable, porous, gas-permeable first electrode (23) and a flat-shaped second electrode (24) lying adjacent, without a gap, to the second housing part (21.2). The faces of the first housing part (21.1) and the first electrode (23) facing one another form a slit-shaped gas channel (25), through which there flows a vapour-saturated, cation-generating carrier gas type or a vapour-saturated, anion-generating carrier gas type [G,V]. The electrode faces facing one another form a slit-shaped liquid channel (26), through which there flows an undersaturated, vapour-absorbing, ion-conducting solution [S]. The electrodes (23,24) are electrically short-circuited by the current lead-in and lead-off systems (27,28) and an external load resistor (29). The gas-side current conduction system is constructed geometrically like that of the gas electrodes of fuel cells and is represented schematically in FIG. 2 rotated through 90°.

Via openings (30.1, 30.2) in the first housing part (21.1), a vapour-saturated carrier gas [G,V]r, (ZP4) with high vapour partial pressure is fed to the gas channel (25) and a reduced quantity of vapour-saturated carrier gas [G,V]m, (ZP1) with reduced vapour partial pressure is carried off. Via openings (31.1, 31.2) in the second housing part (21.2), an undersaturated solution [S]p, (ZP2) with reduced vapour component concentration and low vapour partial pressure is fed to the liquid channel (26) and a two-phase mixture [S]r, [G,V]p, (ZP3) of undersaturated solution [S]r, (ZP3) with raised vapour component concentration and low vapour partial pressure and vapour-saturated carrier gas [G,V]p, (ZP3) with the same low vapour partial pressure is carried off.

When use is made of a cation-generating gas type, such as hydrogen, cations are formed at the phase boundary (23.2) (gas/liquid/solid) of the first electrode (23) as a result of anodic oxidation with the consumption of hydrogen and vapour from the gas channel (25). These migrate transversely to the solution flow through the ion-conducting liquid gap (32) to the second electrode (24) and at its phase boundary (24.1) (gas/liquid/solid) increase the concentration of the solution flowing in the liquid channel (26) as a result of cathodic reduction with the liberation of an equivalent quantity of hydrogen. Here, the electrons flow from the first electrode (23) via the current conduction system (27,28) and the external load resistor (29) to the second electrode (24).

When use is made of a anion-generating gas type, such as oxygen, anions are formed at the phase boundary (23.2) (gas/liquid/solid) of the first electrode (23) as a result of cathodic reduction with the consumption of oxygen and vapour from the gas channel (25). These migrate transversely to the solution flow through the ion-conducting liquid gap (32) to the second electrode (24) and at its phase boundary (24.1) (gas/liquid/solid) increase the concentration of the solution flowing in the liquid channel (26) as a result of anodic oxidation, with the liberation of an equivalent quantity of oxygen. Here, the electrons flow from second electrode (24) via the current conduction system (27,28) and the external load resistor (29) to the first electrode (23).

The same state points (ZP1 to ZP4) as in FIG. 1 are assigned to the fluid flows fed to and carried off from the reaction cell. The substance potential difference of the reaction process inside the liquid gap cell arises with their assignment and hence the inherent voltage of the reaction cell. For this, the vapour-saturated gas flow is also conveyed, with transverse removal by suction of a partial quantity, preferably in the opposite direction to the solution flow and parallel to the electrode faces through the cell.

The state points (ZP1 to ZP4) of the fluid flows are set in the external part of the substance circuit. FIG. 3 shows for example in two schematic state diagrams corresponding to one another the cyclic process carried out isobarically with an aqueous ammonia solution. The carrier gas, as the third component, only makes itself felt here via the overall system pressure, and this is constant in the cyclic process. The saturation temperatures and saturation pressures of the vapour component and the solution are plotted in each case over the solution concentration ξs. Similar cyclic processes can also be carried out and presented with aqueous solutions, which form water vapour as the vapour component, whereby the solutions are diluted in the galvanosorptive reaction process.

The cyclic process according to FIG. 3 contains the following changes of state: a quasi isothermal separation of the solution (ZP4s,ZP-v→ZP1s,ZP4v), with the addition of heat, a substance-constant, internal, recuperative heat recirculation (ZP1s→ZP2′s)ₚ/(ZP3s→ZP4s)ᵣ, a substance-constant temperature drop (ZP2′s→ZP2s)ₚ with heat emission and a quasi isothermal, galvanosorptive reformation of the initial solution (ZP4v, ZP2s→ZP3s, ZP1v) with work being released to the exterior. The cyclic process according to FIG. 3 forms the basis for the process engineering development of the external substance circuit part, as it is represented in FIG. 4 and described below. This development of the external substance circuit part can be applied to any thermally separable solutions in combination with a carrier gas.

The heated gas vapour enricher (42) combined with a phase separator, the solution recuperator (43), the solution cooler (44), the phase separator (45), the solution pump (46) and the gas compressor (47) are assigned to the reaction cell (40) with external load resistor (41). The routing of the substance in the circuit is as follows:

The two-phase mixture [S]r, [G,V]p, (ZP3) carried off from the reaction cell (40) is fed above the bottom to the phase separator (45) and is therein separated into the phases [S]r, (ZP3) and [G,V]p, (ZP3). The vapour-depleted gas [G,V]p, (ZP3) carried off at the head of the phase separator (45) is united with the moderately vapour-depleted gas [G,V]m, (ZP1) carried off from the reaction cell (40), the mixture [G,V]x, (ZP-) is fed by the gas compressor (47) to the gas vapour enricher (42) above the bottom and in the latter conveyed towards the heated vapour-depleting solution [S]r, (ZP4) with vapour uptake. The vapour-enriched gas [G,V]r, (ZP4) carried off at the head of the gas vapour enricher (42) is fed again to the reaction cell (40).

The vapour-enriched solution [S]r, (ZP3) carried off at the bottom from the phase separator (45) is conveyed by the solution pump (46) through the secondary side of the solution recuperator (43), (ZP4) and introduced at the head into the gas vapour enricher (42), (ZP4). The vapour-depleted solution [S]p, (ZP1) is carried off at the bottom of the gas vapour enricher (42), passed through the primary side of the solution recuperator (43), (ZP2′) and through the solution cooler (44), (ZP2) and likewise fed to the reaction cell (40). The substance supply and extraction of the galvanosorptive reaction cell is thus secured via the external part of the substance circuit with the retention of the substance potential difference.

On the process engineering components (40 to 47) of the external substance circuit part, the ringed state points (ZP1) to (ZP4) are indicated according to FIG. 3 in each case at the substance entry and at the substance exit of the components for each individual substance flow marked with its composition [-]. They denote the changes of state of the respective substance flow inside the components (40 to 47). Intermediate states in the substance circuit, such as that at the primary-side solution exit (ZP2′) of the solution recuperator (43) and that of the mixed flow in the gas circuit (ZP-) have also been marked. They have hardly any influence on the operational properties of the galvanosorptive reaction cell.

Heat is fed from the exterior to the gas vapour enricher (42) in order to vaporise the solution [S]r, and in the solution cooler (44) there is extracted from the solution [S]p at the lower temperature level only so much heat that the reaction process inside the galvanosorptive reaction cell (40) takes place adiabatically. The useful electrical work is extracted from the reaction cell (40) via the external load resistor (41). The drive powers of the solution pump (46) and the gas compressor (47) are small, since both conveying devices must convey almost without differential pressure and replace only the flow pressure losses of the complete substance circuit. In the process engineering structure, the external substance circuit is independent of the design of the galvanosorptive reaction cell (FIG. 1 and FIG. 2).

A vapour purification by means of partial backflow condensation to be connected downstream of the gas vapour enricher (42) can be added for the case where, with the thermal separation of solutions with inherent vapour pressure of the solvent, too high a solvent vapour portion is contained in the vapour-saturated carrier gas and the latter, despite its continuous removal from the reaction cell, would hinder the galvanosorptive reaction process inside the reaction cell. The partial backflow condensation can also be carried out recuperatively by using the surplus cooling potential of the vapour-enriched solution [S]r.

A cyclic process for thermogalvanic energy conversion of a special kind is represented in FIG. 5. It becomes possible with external, electrostatic support of the galvanosorptive reaction process. In the two corresponding state diagrams, in which the saturation temperatures and the saturation pressures of solution and vapour component are each plotted over the solution concentration, this is presented in each case as a triangular process. The carrier gas again makes itself felt only via the constant overall system pressure of the substance circulation, whereby P_{tot.}=Pv+PG.

The cyclic process contains as changes of state: a quasi isothermal, thermal separation of the solution (ZP3s,ZP1v→ZP3v,ZP1s), a substance-constant heating of solution (ZP2s→ZP3s) with the addition of heat from the outside, and a (polytropic) galvanosorptive solution reformation (ZP1s,ZP3v→ZP2s,ZP1v) resulting from a superimposition of isothermal substance change and isentropic, substance-constant temperature drop with work being released to the outside.

The state points are again equilibrium states for the fluid flows concerned and are defined by their state magnitudes (P,T,ξs,ξv). The substance potential difference of the polytropic, galvanosorptive reaction process is achieved with the local assignment of the fluid flows on the reaction cell. With the additional, electrostatic support of the electrode potential, the cooling of the vapour-absorbing solution is forced with an increase of the cell working voltage. The polytropic sorption process inside the reaction cell can be conducted in this case adiabatically or non-adiabatically and influenced from outside by the voltage difference conferred electrostatically on the electrodes.

The inherent cell voltage resulting from the substance potential difference of the galvanosorptive reaction cell induces the ion flow and hence the electron flow in the external electrical circuit, whilst the electrostatic voltage superimposed on the inherent voltage gives rise to the temperature drop of the vapour-saturated solution. The additional voltage conferred electrostatically from outside is in the polytropic sorption process proportional to the temperature drop of the solution and inversely proportional to the increase in concentration of the solution. It can amount to several times the inherent voltage value of the cell. Via the working voltage of the reaction cell, its useful electrical work yield increases in proportional to the electrostatic additional voltage. The starting and operating condition for the performance of the polytropic galvanosorptive reaction process is the presence of the inherent voltage of the reaction cell resulting from the substance potential difference.

The cyclic process according to FIG. 5 forms the basis for the process engineering development of the external substance circuit part for making available the substance supply and substance extraction of the reaction cell not in equilibrium. The closed substance circuit is represented in FIG. 6 and is described below. The heated solution heater (51), the gas vapour enricher (52) combined with a phase separator, the phase separator (53), the solution pump (54) and the gas compressor (55) are assigned to the reaction cell (50) with external load resistor (56) and connected, electrostatic activation source (57). The general routing of the substance in the external circuit part applying to such ternary substance systems is as follows:

The two-phase mixture [S]r, [G,V]p, (ZP2) carried off from the reaction cell (50) is fed above the bottom to the phase separator (53) and is therein separated into the phases [S]r, (ZP2) and [G,V]p, (ZP2). The vapour-depleted gas [G,V]p, (ZP2) carried off at the head of the phase separator (53) is united with the moderately vapour-depleted gas [G,V]m, (ZP1) carried off from the reaction cell (50) and the mixture [G,V]x, (ZP-) is fed by the gas compressor (55) to the gas vapour enricher (52) at the bottom and conveyed towards the heated vapour-depleting solution [S]r, (ZP3) with vapour uptake. The vapour-enriched gas [G,V]r, (ZP3) carried off at the head of the gas vapour enricher (52) is fed again to the reaction cell (50).

The vapour-enriched solution [S]r, (ZP2) carried off at the bottom of the phase separator (53) is conveyed (ZP3) by the solution pump (54) through the solution heater (51) and introduced at the head into the gas vapour enricher (52), and the vapour-depleted solution [S]p, (ZP1) carried off at the bottom of the gas vapour enricher (52) is also fed again to the reaction cell (50). The substance supply and extraction of the galvanosorptive reaction cell is thus secured via the external part of the substance circuit. The individual fluid flows of the substance circuit of FIG. 6 are given as an example for the ternary substance system hydrogen as carrier gas in combination with an aqueous ammonia solution.

With extremely small increases in the concentration of the solution (Δξs≦10%) it needs to be taken into account that the inherent voltage of the cell resulting from the substance potential difference and required for the induction of the ion flow will also be very small. In this case, the vapour-depleted solution [S]p to be fed to the reaction cell can be partially pre-cooled in a recuperator, to be provided, in the counterflow to the cooled, vapour-enriched solution [S]r and in this way the substance potential difference and thus the inherent voltage of the reaction cell can be raised.

An additional cleaning of the vapour component by means of partial backflow condensation can be added in case of need. The process engineering development of the substance circuit according to FIG. 6 is also applicable to any substance systems.

The assignment of the electrostatic activation source (62) to the electrical circuit of the galvanosorptive reaction cell (60) with polytropic reaction process is shown in FIG. 7 in an electrical equivalent circuit diagram. The activation source (62) is connected electrically parallel to the reaction cell (60) and to the consumer resistor (61). The activation source (62) consists of a variably adjustable direct current voltage source (63) and two blocking diodes (64,65) limiting the current flow to a few mA. The directions of the potentials of the reaction cell (60) and the activation source (62) are the same, just as the internal resistor (66) of the reaction cell (60) and the consumer resistor (61) are of the same resistance, whereby the consumer resistor (61) can be adapted to the internal resistor (66) of the reaction cell (60).

If the activation source (62) is switched off, the reaction cell (60) generates its low inherent voltage on the basis of its substance potential difference and the working current IZ flows via the consumer resistor (61) back to the reaction cell (60). The working voltage amounts here to ΔU_{eff.}=ΔU_{st.}−I_{eff.}×RZ. When the activation source (62) is switched on, the working current I_{eff.}=IZ+½ID flows via the consumer resistor (61) at the voltage ΔUₒ=ΔU_{st.}+ΔU_{est.} increased by the electrostatic voltage portion U_{est.}, whilst the cell working current (IZ−½ID) flows back to the reaction cell (60) and the conducting-state current ID comes from the activation source (62) and flows to it again. The working voltage of the reaction cell (60) amounts here to ΔU_{eff.}=ΔU_{o-(I}Z−½ID)×RZ, whereby the conducting-state current ID is very much smaller than IZ and thus negligible. The electrical power of the reaction cell (60) increased by the electrostatic voltage portion U_{est.} results from the solution cooling of the polytropic reaction process.

1. Galvanosorptive reaction cell (1) for the conversion of sorptive reaction work into useful electrical work with the feeding-in and carrying-off a ternary substance system consisting of a vapour/carrier gas mixture and a solution absorbing the vapour, characterised by a cell housing (2) which is divided by a media-sealing, galvanically separating peripheral seal (3) into a first housing part (2.1) and a second housing part (2.2) and contains a flat-shaped, porous, gas-permeable first electrode (4) and a flat-shaped, porous, gas- and liquid-permeable second electrode (5), whereby between the electrode faces there is arranged a selectively ion-permeable membrane electrolyte (6), which forms with the porous electrodes (4,5) a mechanically stable composite unit, the first electrode face (4.2) facing away from the membrane electrolyte (6) forms with the first housing part (2.1) a slit-shaped gas channel (7) and a vapour-saturated, ion-generating carrier gas type [G,V] flows through the latter, the second electrode face (5.2) facing away from the membrane electrolyte (6) forms with the second housing part (2.2) a slit-shaped liquid channel (8) and the vapour-absorbing solution [S] flows through the latter and the electrodes (4,5) are electrically short-circuited by current lead-in and lead-off systems (9,10) and an external load resistor (11), whereby via openings (12.1, 12.2) in the first housing part (2.1) vapour-saturated carrier gas [G,V]r with high vapour partial pressure is fed to the gas channel (7) and a reduced quantity of vapour-saturated carrier gas [G,V]m with reduced vapour partial pressure is carried off, via openings (13.1, 13.2) in the second housing part (2.2) an undersaturated solution [S]p with lower vapour concentration and a low vapour partial pressure is fed to the liquid channel (8) and a two-phase mixture [S]r, [G,V]p of undersaturated solution with raised vapour concentration and low vapour partial pressure and vapour-saturated carrier gas with the same low vapour partial pressure is carried off, so that when use is made of a cation-generating gas type and a membrane electrolyte (6) selectively letting through this cation type, cations are formed at the phase boundary (4.1) (gas/solid/electrolyte) of the first electrode (4) as a result of anodic oxidation with the consumption of carrier gas and vapour from the gas channel (7), these migrate through the membrane electrolyte (6) to the second electrode (5) and at its phase boundary (5.2) (gas/liquid/solid) increase the concentration of the solution flowing in the liquid channel (8) as a result of cathodic reduction with the liberation of an equivalent quantity of carrier gas, whilst the electrons from the first electrode (4) flow via the current conduction systems (9,10) and the external load resistor (11) to the second electrode (5) or that, when use is made of an anion-generating gas type and a membrane electrolyte (6) selectively letting through this anion type, anions are formed at the phase boundary (4.1) (gas/solid/electrolyte) of the first electrode (4) as a result of cathodic reduction with the consumption of carrier gas and vapour from the gas channel (7), these migrate through the membrane electrolyte (6) to the second electrode (5) and at its phase boundary (5.2) (gas/liquid/solid) increase the concentration of the solution flowing in the liquid channel (8) as a result of anodic oxidation with the liberation of an equivalent quantity of carrier gas, whilst the electrons from the second electrode (5) flow via the current conduction systems (9,10) and the external load resistor (11) to the first electrode (4).

2. Galvanosorptive reaction cell (20) for the conversion of sorptive reaction work into useful electrical work with the feeding-in and carrying-off a ternary substance system consisting of a vapour/carrier gas mixture and a solution absorbing the vapour, characterised by a cell housing (21) which is divided by a media-sealing, galvanically separating peripheral seal (22) into a first housing part (21.1) and a second housing part (21.2) and contains a flat-shaped, mechanically stable, porous, gas-permeable first electrode (23) and a flat-shaped, second electrode (24) lying adjacent without a gap to the second housing part (21.2), whereby the faces of the first housing part (21.1) and the first electrode (23) facing one another form a slit-shaped gas channel (25) and a vapour-saturated, ion-generating carrier gas type [G,V] flows through the latter and the electrode faces facing one another form a slit-shaped liquid channel (26) and a vapour-absorbing, ion-conducting solution [S] flows through the latter and the electrodes (23,24) are electrically short-circuited by current lead-in and lead-off systems (27,28) and an external load resistor (29), whereby via openings (30.1, 30.2) in the first housing part (21.1) vapour-saturated carrier gas [G,V]r with high vapour partial pressure is fed to the gas channel (25) and a reduced quantity of vapour-saturated carrier gas [G,V]m with reduced vapour partial pressure is carried off, via openings (31.1, 31.2) in the second housing part (21.2) an undersaturated solution [S]p with reduced vapour component concentration and low vapour partial pressure is fed to the liquid channel (26) and a two-phase mixture [S]r, [G,V]p of undersaturated solution [S]r with raised vapour component concentration and vapour-saturated carrier gas [G,V]p with the same low vapour partial pressure is carried off, so that when use is made of a cation-generating gas type, cations are formed at the phase boundary (23.2) (gas/liquid/solid) of the first electrode (23) as a result of anodic oxidation with the consumption of carrier gas and vapour from the gas channel (25), these migrate transversely to the solution flow through the ion-conducting liquid gap (32) to the second electrode (24) and at its phase boundary (24.1) (gas/liquid/solid) increase the concentration of the solution flowing in the liquid channel (26) as a result of cathodic reduction with the liberation of an equivalent quantity of carrier gas, whilst the electrons from the first electrode (23) flow via the current conduction systems (27,28) and the external load resistor (29) to the second electrode (24), or that when use is made of an anion-generating gas type, anions are formed at the phase boundary (23.2) (gas/liquid/solid) of the first electrode (23) as a result of cathodic reduction with the consumption of carrier gas and vapour from the gas channel (25), these migrate transversely to the solution flow through the ion-conducting, liquid gap (32) to the second electrode (24) and at its phase boundary (24.1) (gas/liquid/solid) increase the concentration of the solution flowing in the liquid channel (26) as a result of anodic oxidation, with the liberation of an equivalent quantity of carrier gas, whilst the electrons from the second electrode (24) flow via the current conduction systems (27,28) and the external load resistor (29) to the first electrode (23).

3. Galvanosorptive reaction cell according to claim 1 or 2, characterised in that apart from the ion-generating and system pressure equalising carrier gas involved in the galvanosorptive reaction process any vapour-absorbing solution thermally decomposable into a vapour component and a liquid component can in principle be fed to and carried off from it, whereby hydrogen is a cation-generating carrier gas type and oxygen is a anion-generating carrier gas type and the substance system involved in the galvanosorptive reaction process as a whole is at least a ternary substance system, to which an electrolyte component soluble in the solvent and with negligible inherent vapour-pressure can be added in order to increase the ion-conductivity, whereby the structural materials of the reaction cell behave inertly in respect of the substance system selected.

4. Reaction cell according to claim 3, characterised in that the galvanosorptive reaction process taking place in it is run adiabatically or non-adiabatically, whereby in the case of non-adiabatic running of the process the electrode in contact with the solution or its current conduction system has channels distributed uniformly over its area through which a heat transfer medium flows, whose heat-transferring walls are medium-impermeable.

5. Reaction cell according to claim 3 and 4, characterised in that the substance phase quantities conveyed in the circuit by media-conveying devices are measured so that in the galvanosorptive reaction process a constant-remaining increase in concentration or dilution of the solution and a constant-remaining vapour depletion of the carrier gas is established, whereby the overall system pressure is adjusted by the carrier gas filling of the circuit and the latter is at the same level as or higher than the upper vapour partial pressure reached in the ternary substance circulation.

6. Reaction cell according to the claims (3, 4 and 5) characterised in that there is assigned to the electrodes an activation source which permanently confers on them a quasi electrostatic potential difference of several volts, whereby this potential difference is superimposed on the inherent voltage difference of the cell.

7. Reaction cell (40) with external load resistor (41) according to claim 5 or 6, characterised by the formation of the substance flows fed to and carried off from it into an isobaric, ternary substance circuit with external thermal substance decomposition and external phase separation by the allocation of a heated gas vapour enricher (42) combined with a phase separator, a solution recuperator (43), a solution cooler (44), a phase separator (45), a solution pump (46) and a gas compressor (47), whereby the two-phase mixture [S]r, [G,V]p carried off from the reaction cell (40) is fed above the bottom to the phase separator (45) and the phases [S]r and [G,V]p are separated, the vapour-depleted gas [G,V]p carried off at the head of the phase separator (45) is united with the moderately vapour-depleted gas [G,V]m carried off from the reaction cell and the mixture [G,V]x is fed by the gas compressor (47) to the gas vapour enricher (42) at the bottom and in the latter is conveyed towards the heated vapour-depleting solution [S]r with vapour uptake and the vapour-enriched gas [G,V]r carried off at the head of the gas vapour enricher (42) is fed again to the reaction cell (40), whilst the vapour-enriched solution [S]r carried off at the bottom from the phase separator (45) is conveyed by the solution pump (46) through the secondary side of the solution recuperator (43) (41) and introduced at the head into the gas vapour enricher (42) and the vapour-depleted solution [S]p is carried off at the bottom of the gas vapour enricher (42), passed through the primary side of the solution recuperator (43) and through the solution cooler (44) and fed again to the reaction cell (40).

8. Reaction cell (50) with external load resistor (56) and connected activation source (57) according to claim 5 and 6, characterised by the formation of the substance flows fed to and carried off from it into an isobaric, ternary substance circuit with external thermal substance decomposition and external phase separation by the allocation of a heated solution heater (51), a gas vapour enricher (52) combined with a phase separator, a phase separator (53), a solution pump (54) and a gas compressor (55), whereby the two-phase mixture [S]r, [G,V]p carried off from the reaction cell (50) is fed above the bottom to the phase separator (53) and the phases [S]r and [G,V]p are separated, the vapour-depleted gas [G,V]p carried off at the head of the phase separator (53) is united with the moderately vapour-depleted gas [G,V]m carried off from the reaction cell and the mixture [G,V]x is fed by the gas compressor (55) to the gas vapour enricher (52) at the bottom and in the latter is conveyed towards the heated and vapour-depleting solution [S]r with vapour uptake and the vapour-enriched gas [G,V]r carried off at the head of the gas vapour enricher (52) is fed again to the reaction cell (50), whilst the vapour-enriched solution [S]r carried off at the bottom of the phase separator (53) is conveyed by the solution pump (54) through the solution heater (51) and introduced at the head into the gas vapour enricher (52) and the vapour-depleted solution [S]p carried off at the bottom of the gas vapour enricher (52) is fed again to the reaction cell (50).
